(19) United States
(12) Patent Application Publication
(10) Pub. No.: US 2007/0279429 A1
(43) Pub. Date: Dec. 6, 2007

(54) System and method for rendering graphics

(76) Inventor: Leonhard Ganzer, Bruck an der Mur (AT)

Correspondence Address: DUANE MORRIS LLP, 3200 SOUTHWEST FREEWAY, SUITE 3150, HOUSTON, TX, 77027, US

(21) Appl. No.: 11/445,577

(22) Filed: Jun. 2, 2006

(51) Int. Cl. G06F 15/16

(52) U.S. Cl. 345/582; 345/502

(57) ABSTRACT

An apparatus for conducting simulations and presenting the results in real-time or substantially in real-time to a user comprises one or more CPUs operating in parallel with one or more GPUs. CPU software controls user interface functions and GPU software effects the simulations. Users can interact with the simulation as the simulation is occurring. A non-batch graphics image may be rendered and displays by calculating a first set of parameters in the CPU; initializing, in the CPU, a model for graphics display; generating a texture for display in the CPU; passing the generated texture from the CPU to the GPU via a bus; providing compiled graphics code to the GPU; calculating a timestep in the GPU; updating the passed, generated texture in the GPU; passing the updated texture to a a memory comprising a framebuffer; reading desired contents from the framebuffer by the CPU; and displaying a new property.

### FIELD OF INVENTION

The invention relates generally to the field of software modeling. More specifically, in preferred embodiments, the invention relates to a system and methods of rendering graphics such as may be suitable for use in reservoir simulation. More specifically, in currently contemplated used, the invention relates to a system and methods programmed to implement a computer-aided procedure to the simulation of flow through porous media.

### BACKGROUND OF THE INVENTION

Simulation of liquid and gaseous materials through porous media is an essential discipline of petroleum reservoir technology. Reservoir simulators have been in commercial use since the late 1970s and used in numerous industries including for hydrocarbon exploration. Thus, for almost 40 years, petroleum engineers have used computer models to describe the flow of oil and natural gas through porous rock.

Currently, software executes primarily in or under the control of central processing units (“CPU”) and use of CPUs for simulation is known. Currently, all numerical computations required for flow simulation are executed and performed on the CPUs. Over the years, specialized processors, called graphics processing units or GPUs, have evolved and usually work in tandem with a CPU. Compared to a CPU, a GPU is hardware and thus requires different data storage, memory access, processing and algorithms. For simulations, algorithms for GPUs are different in the way that the computations are, in general, not sequential (in a loop executed in a CPU), but executed simultaneously for a number of elements (a “rendering” step on GPU).

In current reservoir simulations, workflow can be simplified to: (a) preprocessing step, (b) processing step, and (c) post-processing step. The pre-processing step consists of data preparation and grid model generation. For the processing step, the user would conventionally start a separate executable on a computer and wait until the simulation would stop. It is a non-interactive process. The time it takes for a flow simulator to complete the computations varies widely, but typically is somewhere in the order of hours. Once step (b) is complete, the user would start step (c) by launching another software application for the post-processing step. The postprocessing step consists of visualizing the computed results of step (b). If something goes bad during step (b), then the user does not realize it until the simulation is finished and the postprocessing reveals the problem. There is no immediate feedback during the processing and no way to interactively influence the simulation task.

Current reservoir simulators require input of data from, e.g., text files before the simulation begins. After the input, one or more CPUs accomplish the computations necessary for the simulation as batch procedure. Results are graphically represented and analyzed only after the conclusion of the computations. In this traditional approach to simulation, there is no way to interact with the model during the run-time or to change parameters that could affect the results. Any parameter modification requires termination of the process and a restart with a modified input data file.

Over the past twenty years, few fundamental changes occurred in the traditional approach to reservoir simulation. The increase in increasing complexity and size of the simulation grid models was more or less compensated by increases in computing speed due to faster hardware. Today, a single simulation run in batch mode may take up to several days of CPU time on current PC hardware.

### BRIEF DESCRIPTION OF THE DRAWINGS

FIG. 1 is an overview in partial schematic of an exemplary system;

FIG. 2 is a diagrammatic layout of an exemplary system;

FIG. 3 illustrates an exemplary, simplified grid block model of a hydrocarbon reservoir;

FIG. 4 illustrates an exemplary graphical user interface of the prototype to interactively modify parameters during run-time;

FIG. 5 comprises FIG. 5a and FIG. 5b and illustrates an exemplary implementation of the invention as a pixel shader program written in Cg (C for graphics);

FIG. 6 is a flow chart of a first exemplary method; and

FIG. 7 is a flow chart of a second exemplary method.

### BRIEF DESCRIPTION OF EMBODIMENTS OF THE INVENTIONS

In exemplary embodiments described herein below, the invention comprises apparatus and methods of use of providing substantially real-time interactive modeling such as might be used in simulation of hydrocarbon reservoirs or the like. That which is described in software can also be implemented in hardware.

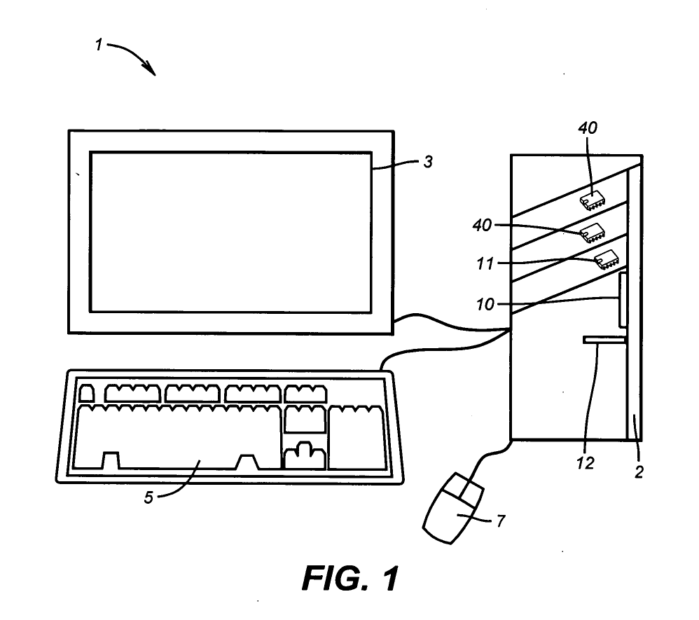

Referring now to FIG. 1, modeling system 1 for rendering graphics comprises system bus 2; central processing unit (CPU) 10 operatively in communication with system bus 2; graphics processing unit (GPU) 40 operatively in communications with system bus 2; and video processor 11 operatively in communications with system bus 2. Video processor 11 is used to convert data for display, e.g. to monitor 3.

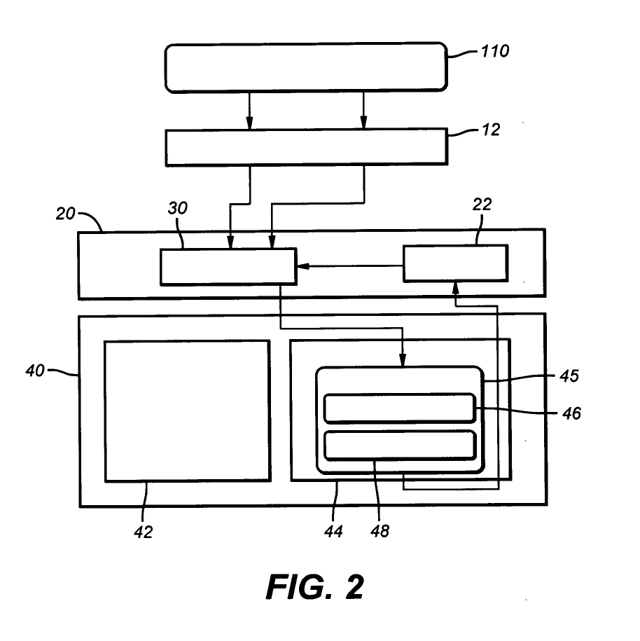

Users may use standard devices such as keyboard 5 and/or mouse 7 to aid with interaction by a user with modeling system 1. The claimed system and methods move dynamic model calculation from CPU 10 to GPU 40. A predetermined number of dynamic data elements, typically all such dynamic data elements, are stored in textures 30 (FIG. 2) in memory, e.g., video memory 20 (FIG. 2), which is accessed by pixel shader software 45 (FIG. 2) loaded in pixel shader processor 44 (FIG. 2).

As currently contemplated, CPU 10 is a microprocessor such as from the Intel(R) Pentium family of CPUs, the AMD(R) Athlon family of CPUs, or the like, including single and multiple core, 32 and 64 bit versions of these microprocessors. CPU 10 may be a standalone CPU, a plurality of CPUs, a CPU comprising multiple cores, or a plurality of CPUs comprising multiple cores.

As currently contemplated, GPU 40 is a specialized graphics processing such as the Quadro FX Series, Geforce 6 and 7 Series marketed by nVIDIA Corp. or the Radeon X600 Series marketed by ATI. In certain currently contemplated embodiments, GPU 40 is a single GPU, though in currently contemplated alternative embodiments GPU 40 comprises a plurality of GPUs 40.

CPU 10 and GPU 40 typically support conditional branching, although different programming languages will handle branching differently. Languages such as assemblers may be used, though such is not practical for large applications; Cg, C for Graphics by nVIDIA Corp. and available at http://developer.nvidia.com/Cg/; HLSL—High-Level Shader Language, DirectX 9 only, available from Microsoft Corp.; GLSL—OpenGL 2.0 shading language, widely available, e.g. from the Internet; Brook—a computing language available at http://graphics.stanford.edu/projects/brookgpu; and/or Sh—Shader Language of University of Waterloo, http://libsh.org. Many of these, e.g. C_{g}, provide practically all necessary mathematical functions also known from the C programming language for the required purposes.

In general, user interface software 100 (part of 110 in FIG. 2) is adapted to execute in CPU 10 and provides user control over interface and visualization. In a preferred embodiment, user interface software 100 is also adapted to calculate predetermined constant variables and time independent parameters for a simulation and to generate a texture, e.g. texture 30 (FIG. 2).

Graphics software 120 (not shown but implicit in FIG. 2) is adapted to execute in GPU 40 and, in preferred embodiments, adapted to calculate a timestep and to update texture 30 (FIG. 2). Graphics software 120 is used to implement a programming model, i.e. the data model, algorithms, and logic described in these methods to effect the simulation which used to execute in CPU 10 now execute in GPU 40 and may include, e.g., pixel software such as 45 in FIG. 2).

In preferred methods, as described below, processing and simulation occur substantially in parallel in GPU 40 and CPU 10 and interaction with a user may occur during a processing step which is executed while running post-processing software application. Numerical computations for the simulation are executed in GPU 40 and the results are delivered to the software application executing in CPU 10 for visualization in real-time or substantially in real-time, e.g. user interface software 100. Thus, it is therefore possible for a user to check on simulation results while those results are being computed. Moreover, it is possible for a user to change settings during the simulation process interactively, e.g. settings such as time-step lengths, oil well rates, oil production/injection rates, and the like, or combinations thereof. In conventional simulation, many of these settings must be set beforehand as once the processing job is started, there is no more option to modify those settings from outside.

Modeling system 1 typically comprises system memory 12 operatively coupled to CPU 10 and video memory 20 (FIG. 2) operatively coupled to GPU 40. Typically, flow simulation requires use of many textures 30 (FIG. 2) where some textures 30 are generated from one or more time-independent parameters and some textures 30 are used for one or more time-dependent parameters. Textures 30 are stored in video memory 20 (FIG. 2) that is accessible to, and, in certain embodiments under the exclusive control of, GPU 40.

In the operation of an exemplary embodiment, referring generally now to FIG. 2, CPU-resident application 110 is software used to effect dynamic flow modeling and comprises a model, e.g. of a grid block or of other rock and fluid properties necessary for the complete description of a mathematical model of interest in the simulation. Typically, parameters that describe a static component of the model and additional parameters necessary for dynamic flow calculations are stored in system memory 12 and transferred from there as textures 30 into video memory 20. Pixel shader program 45 is preferably written in a computer language such as C_{g} (C for Graphics, available from nVIDIA and executes in pixel shader processor 44 which is a part of GPU 40.

When the dynamic flow calculation is started, a render process is initiated and pixel shader program 45 is loaded into one or more GPUs 40, each of which comprises one or more pixel shader processors 44. For GPUs comprising a plurality of pixel shader processors 44, several grid blocks can be executed and processed simultaneously. Data from video memory 20 will be transferred to pixel shader processor 44 of GPU 40 at the beginning of a timestep which marks the initiation of a render process.

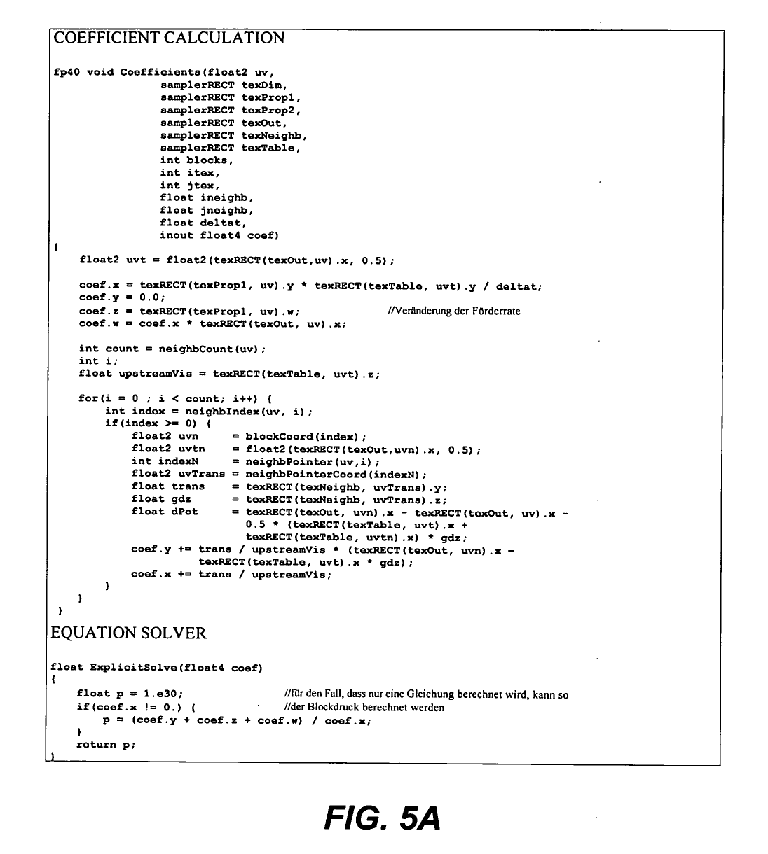

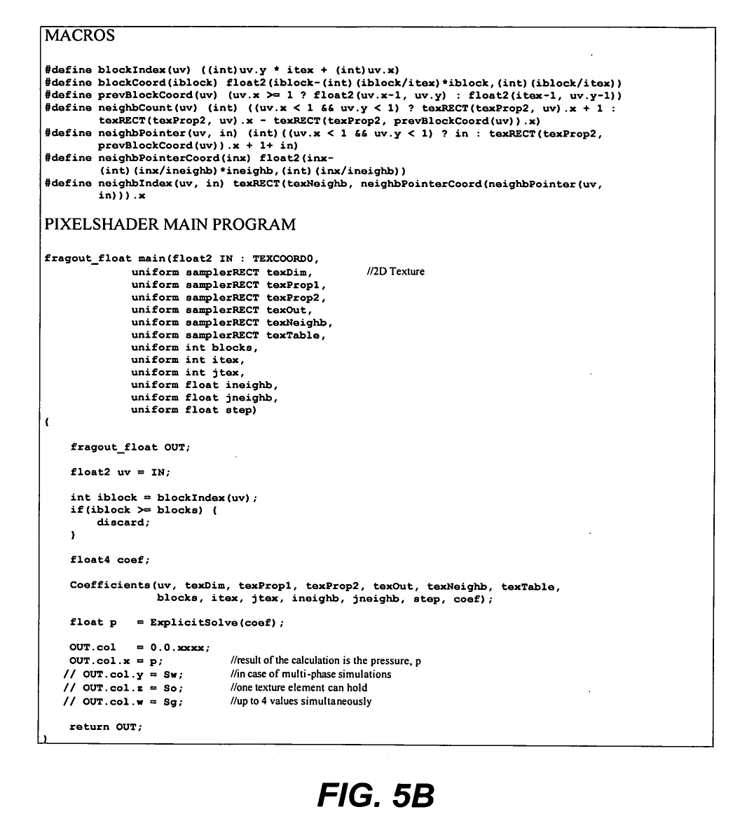

An exemplary source snippet is provided in FIGS. 5a and 5b, collectively referred to as FIG. 5, which illustrates the following exemplary functions in source code:

PIXELSHADER MAIN PROGRAM
access to textures and scalars in video memory, calls other functions
and assigns the calculated results to parameter OUT
COEFFICIENT CALCULATION
calculates the necessary coefficients coef based on actual parameter
values and existing neighbor connection information
EQUATION SOLVER
solves the equations for a grid block
MACROS
available to all functions; calculate frequently required values

As illustrated in FIG. 5, textures 30 can be identified in the PIXELSHADER MAIN PROGRAM of FIG. 5, where they are defined for example as “uniform samplerRECT texDim.” Access to the elements of texture 30 is granted via texture coordinates and, in the case of C_{g} programming, with the function texRECT as can be seen from the source code example.

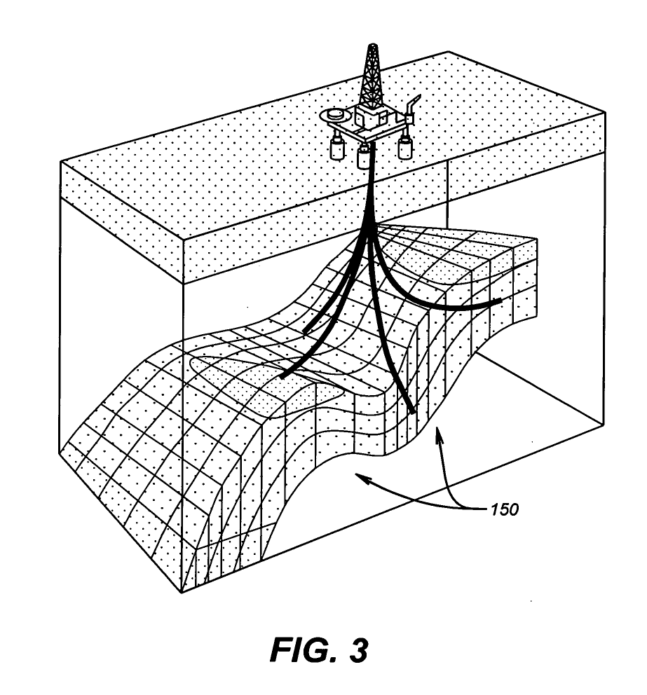

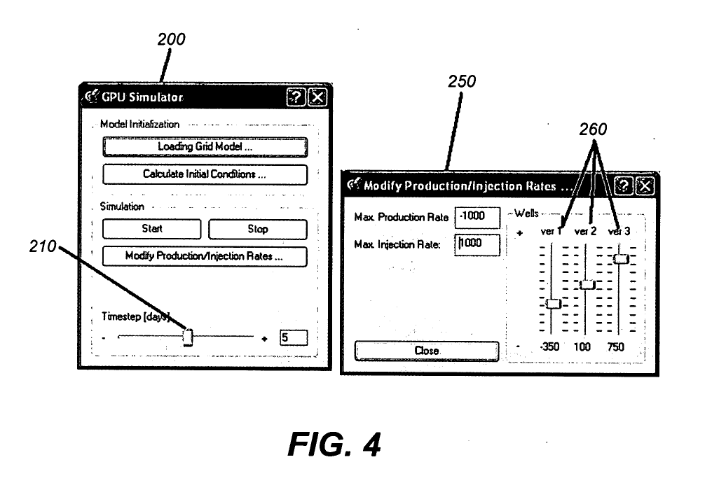

Referring now to FIG. 4, the simulation process can then be started from graphical user interface 200, 250. In an exemplary embodiment, a render pass is initiated using the OpenGL function glBegin(GL_QUADS). By definition, a render pass will process all elements of a defined two dimensional texture 30 (FIG. 2) which means that more elements (grid blocks 150 as illustrated in FIG. 3) will be passed through the calculation procedure than exist in the model. The problem evolves, because in general the total number of grid blocks 150 does not fit exactly into a rectangle without a remainder, and therefore some elements of the last row of texture 30 may not used for the calculation. In a preferred embodiment, two dimensional textures 30 are allocated with the maximum number of columns to be able to handle a maximum number of grid blocks 150 in one render pass (for example, if the maximum dimension of the two dimensional texture would be 1000 and the simulation had 1800 grid blocks 150, then the program would allocate a texture with dimensions 1000×2, which results in 200 elements that are not used).

PIXELSHADER MAIN PROGRAM checks the block index of every element in texture 30 (FIG. 2) against the maximum number of grid blocks 150 (FIG. 3) of the simulation model. At first, the coefficients are calculated, such as illustrated at COEFFICIENT CALCULATION (see also 46 in FIG. 2). The resulting coefficients are transferred back into the main program from where they are passed on to the solver, such as illustrated at EQUATION SOLVER (see also 48 in FIG. 2). The mathematical model used for the coefficient calculation is described in more detail herein below.

The result of the calculation procedure—in this case the pressure of grid block 150 (FIG. 3)—is stored on fragout float OUT which is located in pixel buffer 22 (FIG. 2).

At the end of the render process all grid block results are stored in pixel buffer 22 (FIG. 2). In this way, a loop over all grid blocks as required in traditional programming on CPUs can be omitted. The end of the render pass also means by definition that every grid block was calculated exactly one time. In the exemplary implementation shown in FIG. 5, the results of the calculation represents the grid block pressures at the end of the actual time step.

Those newly calculated values temporarily stored in pixel buffer 22 (FIG. 2) overwrite the actual values of texture 30 texOut. This may be accomplished with the OpenGL function glCopyTexSubImagetwo dimensional. In this way, texture 30 (FIG. 2) is updated and contains the starting values for the subsequent time step and a new render pass in GPU 40 (FIG. 1) can be initiated.

Referring now to FIG. 4, users can interface with and affect the simulation process to modify parameters interactively during the calculation. For example, simulated well production or injection rates can be modified on graphical user interface 200,250 such as through slider 210,260 or other equivalent means, e.g. simulated knobs or spinners (not shown). Similarly, time step regulation can be influenced from user interface 200,250.

A change in the parameters such as entered by a user by using graphical user interface 200,250 invokes a corresponding change in the appropriate texture 30 (FIG. 2) in video memory 20 (FIG. 2). In the subsequent render pass (time step) those modifications are already represented in textures 30 that are loaded into GPU 40 (FIG. 2) for processing. Hence, the user interaction is already—substantially instantaneously—considered in the subsequent time step solution and affects the simulation results. In the exemplary implementation shown in FIG. 4, the user can modify the well rates of any well which will cause a modified value in the corresponding element of texture 30 texPropl.w. A modification of these elements will result in a different pressure solution, which is visualized immediately, because the results of each time step are visualized.

Due to the fact that the simulation results obtained from the process described above are already located in video memory 20 (FIG. 2, i.e. in texture 30 texOut in FIG. 5), the graphical display of the pressure solution is fast and very efficient compared to CPU-based solutions, where the computation results typically reside in system memory 12 (FIG. 1) and must be transferred to video memory 20 (FIG. 2) through bus 2 (FIG. 1) that connects CPU 10 (FIG. 1) with,its associated video system 11 (FIG. 1).

For the purpose of display, the calculated pressure result of grid block 150 (FIG. 3) (which is a floating point number) may further converted to a color.

The simulation model illustrated in FIG. 5 is an implementation of a single-phase black-oil model, which is based on the following mass balance equation of a component c in a phase p:

$${\sum }_{j = 1}^{N} {τ}_{ij} [ {\sum }_{p = 1}^{P} {( {x}_{pc} {λ}_{p} {D}_{p} )}_{ij}^{n + 1} {( {Φ}_{pj} - {Φ}_{pi} )}^{n + 1} ] + {\sum }_{p = 1}^{P} {( {q}_{p} {D}_{p} {x}_{pc} )}_{i}^{n + 1} = \frac{{V}_{i}}{Δ t} {{Δ}_{t} [ φ {\sum }_{p = 1}^{P} ( {S}_{p} {D}_{p} {x}_{pc} ) ]}_{i}$$

where,
N=number of grid block neighbors
i=index of the actual grid block
j=index of the actual neighboring grid block
τᵢⱼ=grid block transmissibility between neighboring blocks
P=number of fluid phases p, e.g. water, oil or gas
X_{PC}=molar fraction of component c in phase p
λ_{P}=mobility of phase p
Dₚ=molar density of phase p
Φₚᵢ=pressure potential of phase p in grid block i
n+1=time level; ⁿ⁺¹
qₚ=production/injection well rate of phase p
Vᵢ=actual grid block volume
Δt=time step length
Δₜ=time operator; difference between time levelⁿ andⁿ⁺¹
φ=porosity
S_{P}=saturation of phase p

An extension to multi-phase flow calculation is following the mass balance equation given above, but the coefficient calculation and solver must be adjusted accordingly.

The programming logic described herein can be applied to structured (from finite difference discretization) and unstructured grid block models as resulting from finite element or finite volume discretizations.

Referring again to FIG. 2, in typical embodiments, the dynamic flow calculation (simulation) will entirely performed in GPU 40. To do this, as an initialization step pixel shader program 45 is loaded into pixel shader processor 44 which can access those textures 30 located in video memory 20. Pixel shader program 45 executes all calculation steps required for one solution of a timestep and delivers the results to pixel buffer 22 in video memory 20. Those results are then stored back into video memory 20 as updated textures 30. Updated textures 30 provide the starting value for a new solution step, i.e. at the next time step and the process is repeated as desired. Moreover, video system 11 (FIG. 1) may display updated textures 30 such as would appear like those shown in FIG. 3.

Textures 30 replace the traditional concept of arrays and vectors for data storage as used in current CPU programming. Textures 30 are preferably two dimensional textures which allow storing four floating point numbers for each element of texture 30. For example, one element of a floating point texture “texF” structure comprising four parameter properties that can be accessed through a so called “swizzle” operator as shown below:

texF.x stores 1^{st} parameter
texF.y stores 2^{nd} parameter
texF.z stores 3^{rd} parameter
texF.w stores 4^{th} parameter

In this embodiment, the texF structure is used to store up to 4 properties of the grid blocks. However, simulation of the grid block model most typically requires more than 4 parameters per grid block and therefore several different textures 30 are created, as illustrated in the source code example of FIG. 5.

Following the initialization step, the simulation process can be started which comprises a rendering process as normally used for visualizing three dimensional objects in graphics applications. In an embodiment, the simulation process is used now to perform scientific calculations following the rules as illustrated in FIG. 5.

Every grid block of the simulation model represents one element of texture 30 (a “texel”) and is processed accordingly. The rendering process guarantees that every texel is processed exactly one time and therefore one complete render pass of GPU 40 represents one solution step of the simulation, i.e. a single timestep.

Before start of the simulation, software executing in CPU 10 calculates all values that do not change within a timestep or otherwise which remain constant throughout the entire simulation process. Typical descriptions of the simulation model, as illustrated in FIG. 5, require storage of the following data:
Location of grid nodes (usually the center point of grid blocks)
Vertical dimension of grid blocks (grid block thickness)
Pore volumes of grid blocks
Number of neighbors for each grid block
Fluid density under standard conditions
Rock and fluid compressibility
Fluid viscosity
Grid block transmissibilities for each grid block connection
Initial pressures for all grid blocks
Initial production/injection rates for all well blocks

All of these parameters are calculated by application 110 in CPU 10 during the initialization step and are stored to system memory 12. These model parameters and initial block values are transferred from system memory 12 to video memory 20 where they are stored as textures 30 or scalar values. This preferably is accomplished by means of OpenGL library functions. For example, the OpenGL function glTexImagetwo dimensional transfers vectors of system memory 12 to textures 30 in video memory 20 where they can be accessed by GPU 40, generating two dimensional textures as illustrated in the exemplary implementation in FIG. 5 and illustrated in the chart below:

Name of texture

| | |
|---|---|
| texDim | |
| .x | X-coordinate of grid node |
| .y | Y-coordinate of grid node |
| .z | Z-coordinate of grid node |
| .w | vertical dimension of grid node |
| texProp1 | |
| .x | volume of grid node |
| .y | pore-volume of grid node |
| .z | not used |
| .w | production/injection rate of grid node |
| texProp2 | |
| .x | number of neighbor grid blocks |
| .y | index for rock properties |
| .z | Index for fluid properties |
| .w | not used |
| texOut | |
| .x | actual pressure of grid node |
| .y | oil saturation of grid node |
| .z | water saturation of grid node |
| .w | gas saturation of grid node |
| texNeighb | |
| .x | block Index to neighbor grid blocks |
| .y | block pair transmissibility |
| .z | height difference between two neighboring grid nodes |
| .w | not used |
| texTable | |
| .x | fluid density |
| .y | rock compressibility |
| .z | fluid viscosity |
| .w | not used |

The length of texture 30, in most cases, represents the total number of grid blocks in the model, except for texNeighb whose length represents the total number of neighbor connections in the simulation model.

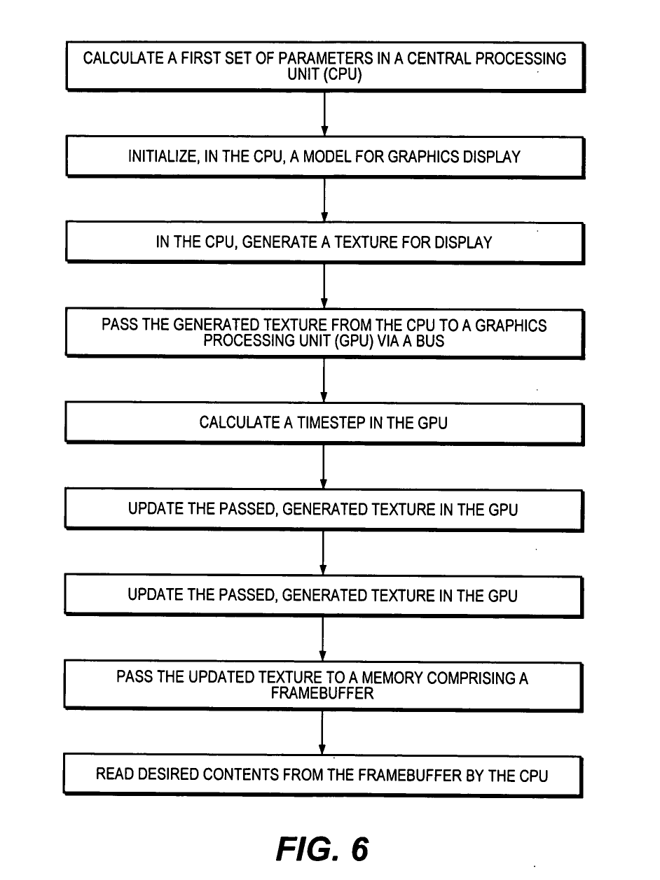

Referring now to FIG. 6, after model initialization is complete, all subsequent calculations are performed and controlled by GPU 40 (FIG. 1), i.e. computation of flow simulation; e.g. fluid flow through reservoir rock formations, occurs in GPU 40 and user interface software, e.g. comprising software to effect visualization of simulation results, in CPU 10 (FIG. 1), allowing the user to interact with the simulation model while the computations are being executed. Although the basic, fundamental equations (such as partial differential equations) used to model fluid flow may be the same as in conventional simulations, the actual algorithms used to calculate the approximate solutions of those equations are different due to the different programming paradigm on GPU hardware.

A graphics image of simulation results may be rendered in a non-batch mode, i.e. real-time or near real-time where near-real time is meant to be understood as appearing to be operating in real-time by a human observer of the results of the rendering. In a first contemplated method using modeling system 1, a first set of parameters is calculated in CPU 10 (FIG. 1) by generation software 102 (not shown) executing in CPU 10. The first set of parameters may comprise a time independent parameter.

Generation software 102 initializes, in CPU 10 (FIG. 1), a model for graphics display; generates texture 30 (FIG. 2) in CPU 10 for display such as to video monitor 3 (FIG. 1); and passes the generated texture from CPU 10 to GPU 40 (FIG. 1) via system bus 2 (FIG. 1).

Compiled graphics software 122 (not shown) is provided to GPU 40 (FIG. 1). Graphics software 122 may be precompiled, e.g. within CPU 10 (FIG. 1), or provided on-the-fly by CPU 10 to GPU 40.

Passing of the texture to GPU 40 (FIG. 1) and the compilation and loading of graphics software 122 may occur substantially simultaneously or independently.

Once GPU 40 graphics software 122 installed, graphics software 122 calculates a timestep in GPU 40 (FIG. 1). As used herein, “timestep” describes means certain time periods used by a mathematical model whose execution may extend over a certain time period, e.g. simulation of a reservoir between the years 1990 and 2010. The mathematical model requires that this time period be split into smaller increments which are “timesteps.” Typical timestep lengths in reservoir simulation are in the range of days, e.g. 5 to 30 days. The result of the first timestep provides the starting point for the second timestep and so on. This process is called time discretization wherein the mathematical model consists of partial differential equations that do not offer analytical solution. Therefore a numerical solution is sought by discretization. The spatial discretization results in grid blocks, the time discretization results in timesteps.

Graphics software 122 updates the passed, generated texture and passes the updated texture to buffer 22 (FIG. 2) in video memory 20 (FIG. 2), e.g. a framebuffer.

Display software 114 (not shown), executing in CPU 10 (FIG. 1), reads desired contents from buffer 22 (FIG. 2) and displays a new property, based on the read desired contents, such as to video monitor 3 (FIG. 1). Display software 114 may be part of generation software 102 or may be a separate software component. For use in reservoir simulations, the displayed contents from buffer 22 may be suitable for simulation of a reservoir at a fine geo-cellular scale.

Idle states of CPU 10 (FIG. 1) and/or GPU 40 (FIG. 1) may be utilized during the processing. For example, GPU 40 may be in an idle state when CPU 10 calculates the first set of parameters, CPU 10 initializes the model for graphics display, CPU 10 generates the texture for display, the reading of the framebuffer by CPU 10, or a combination thereof. Moreover, CPU 10 may be in an idle state during the calculation of the timestep.

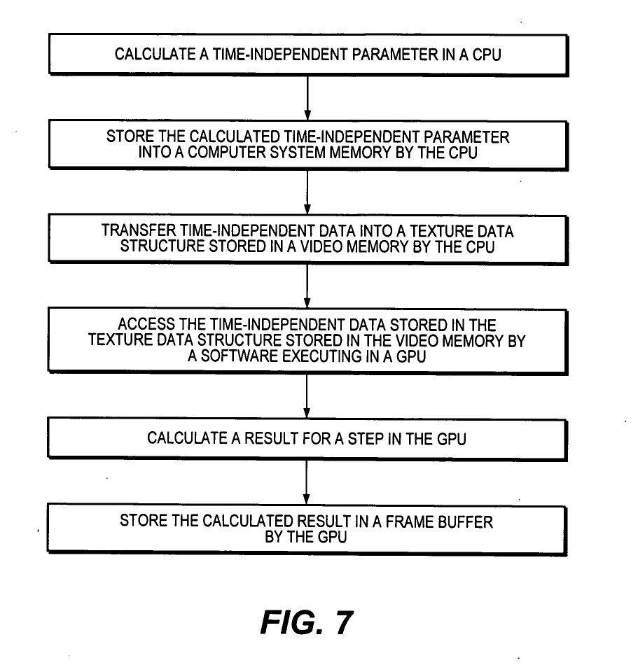

Referring now to FIG. 7, in an alternative method embodiment, reservoir simulation begins with initiating a preprocessing step executed in CPU 10 (FIG. 1). This preprocessing step comprises preparing data for use in the desired reservoir simulation and generation of a grid model for use in the simulation. All software for execution in GPU 40 (FIG. 1) may be compiled within CPU 10 and loaded from CPU 10 into GPU 40 before GPU 40 begins executing the software, i.e. GPU software is pre-compiled, or portions of that software may be compiled in CPU 10 and provided to GPU 40 while GPU 40 is executing a different portion of the software.

When the initialization has completed, reservoir simulation software executes by executing post-processing user interface software 123 (not shown) within CPU 10 (FIG. 1) and substantially concurrently performing flow simulation processing in GPU 40 (FIG. 1). The substantially concurrently performing flow simulation processing comprises computing one or more numerical calculations required for the simulation in GPU 40 and communicating results of the computed numerical calculations to post-processing software 123 executing in CPU 10 substantially in real-time.

A user may be allowed to obtain a simulation result in substantially real-time while the result is being computed such as by presenting visual representations to the user on a video monitor. In these embodiments, a user may also be allowed to interactively change a desired setting during the execution of the reservoir simulation software. For example, the user may be allowed to change a time-step length, an oil well rate such as an oil production/injection rate, or the like, or a combination thereof.

If desired, simulation of fluid flow through reservoir rock occurs in GPU 40 (FIG. 1) and computation for providing visualizing results occurs substantially simultaneously in CPU 10 (FIG. 1).

CPU 10 (FIG. 1) and GPU 40 (FIG. 1) may additionally provide for processing that utilizes conditional branching.

In a further alternative method of reservoir simulation, in a controlled process executing in CPU 10 (FIG. 1), software calculates a time-independent parameter, stores the calculated time-independent parameter into computer system memory 12 (FIG. 1), and transfers time-independent data into a texture data structure stored in video memory 20 (FIG. 2). Software executing in CPU 10 may allow user interaction with the simulation process.

In a substantially simultaneously occurring process within GPU 40 (FIG. 1), the time-independent data stored in the texture data structure in video memory 20 (FIG. 2) are accessed by software executing in GPU 40. Software executing in. GPU 40 then calculates a results for a step and stores the calculated result in buffer 22 (FIG. 2).

The calculated result may then be used to initialize a new time step and the calculated result used to update the time-independent data stored in the texture data structure in the video memory.

It will be understood that various changes in the details, materials, and arrangements of the parts which have been described and illustrated above in order to explain the nature of this invention may be made by those skilled in the art without departing from the principle and scope of the invention as recited in the appended claims.

I claim:

1. A system for rendering graphics, comprising:
a. a system bus;
b. a central processing unit (“CPU”) operatively in communication with the system bus;
c. software executable in the CPU, the software adapted to calculate a constant variable and a time independent parameter for a simulation, to generate a texture, and to provide a user interface;
d. a graphics processing unit (“GPU”) operatively in communications with the system bus;
e. software executable in the GPU adapted to calculate a time step and to update a texture; and
f. a video processor operatively in communications with the system bus.

2. The system of claim 1, wherein the GPU comprises a plurality of GPUs.

3. The system of claim 1, wherein the CPU is selected from the group consisting of a standalone CPU, a plurality of CPUs, a CPU comprising multiple cores, and a plurality of CPUs comprising multiple cores.

4. The system of claim 1, further comprising:
a. a system memory operatively coupled to the CPU; and
b. a video memory operatively coupled to the GPU.

5. The system of claim 1, wherein the CPU and GPU each support conditional branching.

6. A method of rendering a non-batch graphics image, comprising:
a. calculating a first set of parameters in a central processing unit (“CPU”);
b. initializing, in the CPU, a model for graphics display;
c. generating a texture for display in the CPU;
d. passing the generated texture from the CPU to a graphics processing unit (“GPU”) via a bus;
e. providing compiled graphics code to the GPU;
f. calculating a timestep in the GPU;
g. updating the passed, generated texture in the GPU;
h. passing the updated texture to a memory comprising a framebuffer;
i. reading desired contents from the framebuffer by the CPU; and
j. displaying a new property.

7. The method of claim 6, wherein the first set of parameters comprise a time independent parameter.

8. The method of claim 6 wherein the GPU is in an idle state when at least one of (i) the CPU calculates the first set of parameters, (ii) the CPU initializes the model for graphics display, or (iii) the CPU generates the texture for display.

9. The method of claim 6, wherein the passing of the texture to the GPU and the compilation and loading of the graphics code occur substantially simultaneously.

10. The method of claim 6, wherein the CPU is idle during the calculation of the timestep.

11. The method of claim 6, wherein the GPU is idle during the reading of the framebuffer by the CPU.

12. The method of claim 6, further comprising allowing interaction with a predetermined set of parameters of the simulation that usually are modified only from a text file and executed in batch mode.

13. The method of claim 6, wherein the displayed framebuffer contents are suitable for simulation of a reservoir at a fine geo-cellular scale.

14. A method of reservoir simulation, comprising:
a. initiating a preprocessing step in a central processing unit (“CPU”), the preprocessing step comprising:
i. preparing data for use in a reservoir simulation; and
ii. generating a grid model for use in the simulation; and
b. executing reservoir simulation software, further comprising:
i. executing post-processing user interface software within the CPU; and
ii. concurrently performing flow simulation processing in a graphics processing unit (“GPU”), comprising:
(1) computing numerical calculations required for the simulation in the GPU; and
(2) communicating results of the computed numerical calculations to the post-processing software substantially in real-time.

15. The method of claim 14, further comprising allowing a user to obtain a simulation result in substantially real-time while the result is being computed.

16. The method of claim 14, further comprising allowing a user to interactively change a desired setting during the execution of the reservoir simulation software.

17. The method of claim 16, wherein the setting comprises at least one of (i) a time-step length or (a) an oil well rate.

18. The method of claim 17, wherein the oil well rate comprises an oil production/injection rate.

19. The method of claim 14, wherein:
a. computation required to simulate fluid flow through reservoir rock occurs in the GPU; and
b. computation for providing visualizing results occurs substantially simultaneously in the CPU.

20. The method of claim 14, wherein the GPU processing utilizes conditional branching.

21. The method of claim 14, wherein code for execution in the GPU is compiled on the CPU and loaded into the GPU at least one of (i) before executing the code (pre-compiled) or (ii) while running the code.

22. A method of reservoir simulation, comprising
a. in a central processing unit (“CPU”) controlled process:
i. calculating a time-independent parameter in a CPU;
ii. storing the calculated time-independent parameter into a computer system memory by the CPU; and
iii. transferring time-independent data into a texture data structure stored in a video memory by the CPU; and
b. in a substantially simultaneously occurring graphics processing unit (“GPU”) controlled processes:
i. accessing the time-independent data stored in the texture data structure in the video memory by software executing in the GPU;
ii. calculating a result for a step in the GPU; and
iii. storing the calculated result in a frame buffer by the GPU.

23. The method of claim 22, further comprising:
a. using the calculated result to initialize a new time step; and
b. using the calculated result to update the time-independent data stored in the texture data structure in the video memory.

24. The method of claim 22, further comprising providing software executing in the CPU to allow a user to interact with the reservoir simulation at least substantially in real-time.
